(19) United States
(12) Patent Application Publication
(10) Pub. No.: US 2006/0130530 A1
(43) Pub. Date: Jun. 22, 2006

(54) Method of doping silica glass with an alkali metal, and optical fiber precursor formed therefrom

(76) Inventors: James G. Anderson, Dundee, NY (US); Adam J. G. Ellison, Painted Post, NY (US); Susan L. Schiefelbein, Ithaca, NY (US)

Correspondence Address: CORNING INCORPORATED, SP-TI-3-1, CORNING, NY, 14831, US

(21) Appl. No.: 11/019,721

(22) Filed: Dec. 21, 2004

(51) Int. Cl. C03B 37/027; C03B 32/00

(52) U.S. Cl. 65/394; 65/417; 65/30.13

(57) ABSTRACT

A method of making an optical fiber precursor includes generating vapors from an alkali metal source comprising compound containing oxygen and one or more alkali metals and applying the vapors to a surface of a glass article comprising silica at a temperature that promotes diffusion of the alkali metal into the surface of the glass article. An optical fiber has a core comprising silica and an alkali metal oxide of the form X₂O, where X is selected from the group consisting of K, Na, Li, Cs, and Rb, wherein a concentration of the alkali metal oxide along a length of the core is uniform.

### FIELD OF THE INVENTION

The invention relates generally to a method of making a low loss optical fiber. More specifically, the invention relates to a method of doping a silica glass article with an alkali metal and an optical fiber precursor formed from the doped silica glass article.

### BACKGROUND OF THE INVENTION

Optical fibers in commercial use are mostly based on silica glass. The theoretical minimum attenuation of pure silica is generally accepted to be about 0.15 db/km at 1,550 nm. For optical fibers based on silica glass, attenuation losses have been reduced to the point where most of the remaining attenuation is due to intrinsic scattering within the glass material. It has been demonstrated that intrinsic scattering loss in silica glass can be effectively reduced by doping silica glass with alkali metals, either alone or in combination with other materials such as fluorine.

Optical fibers exhibiting low losses are commonly manufactured by chemical vapor deposition (CVD) processes. However, it is difficult to dope silica glass with alkali metals using conventional (CVD) processes such as outside vapor deposition (OVD), vapor axial deposition (VAD), and modified CVD (MCVD) wherein soot is a precursor to the final glass. It is well known that alkali metals may crystallize silica. Thus, the soot produced by these processes tends to crystallize before it can be consolidated into dense glass, resulting in both cristobalite defects in the final glass and near-total volatilization of the alkali metal dopant. The soot produced by these processes would also generally contain H₂O, which may dissociate during further processing of the soot to form OH⁻. OH⁻ has a deleterious effect on fiber attenuation, particularly when present in the core of the fiber. Typically, this OH⁻ is removed by flowing chlorine through the soot preform at an elevated temperature. Unfortunately, such a drying step would likely strip what little alkali metal remained in the soot.

It is obvious from the foregoing that an alternative method of doping silica glass with an alkali metal is needed. U.S. Patent Application Publication No. 2004/0057692 (Ball et al.) describes such an alternative method. The method involves doping silica glass with an alkali metal by diffusion. As illustrated in FIG. 1, a silica glass tube 100 suitable for manufacture of an optical fiber is mounted in a glass-working lathe 101. A reservoir 102 is provided near one of the ends of the tube 100. The reservoir 102 contains an alkali metal source 104, which may initially be in solid or liquid form. The alkali metal source 104 is an alkali metal halide, in particular an alkali metal bromide, iodide, or fluoride, where the alkali metal may be K, Na, Li, Cs, or Rb. While the tube 100 is rotated, a burner 106 heats the alkali metal source 104 to produce vapors. At the same time, oxygen 108 is flowed into the tube 100 through an inlet 110 and rotating seal 112. The oxygen 108 carries the alkali metal source 104 vapors downstream of the reservoir 102. A burner 114 heats the portion 100a of the tube 100 downstream of the reservoir 102 to a temperature that would promote rapid diffusion of the alkali metal into the inner surface of the tube 100. The Ball et al. publication also describes etching of the inner surface of the tube 100 to a depth sufficient to remove unwanted impurities that may have diffused through the inner surface, and collapsing of the tube 100 into a solid glass rod, which, after removal of the portion containing the reservoir 102, may serve as an optical fiber precursor.

The approach described in the Ball et al. publication is very promising, but there are challenges to be overcome. In particular, it is difficult to obtain high doping levels of alkali metal and uniform doping along the length of the tube. High doping levels are desirable because the high diffusivity of alkali metals at high temperature greatly reduces the peak alkali metal content in the core during fiber draw. Therefore, a high initial level of alkali metal is required to obtain the desired level in the final fiber. It is necessary for the oxygen carrier gas to participate in the reaction to incorporate the alkali metal into silica by diffusion. Very high oxygen flow rates and high alkali metal halide vapor pressures are required to obtain higher levels of alkali metals in the doped silica tube. These conditions create problems for uniformity in doping along the length of the tube. In particular, the high oxygen flow rates entrain droplets of alkali metal halide, which are deposited ballistically along the length of the tube, with larger droplets landing close to the source and smaller droplets landing furthest from the source. This produces a characteristic alkali metal concentration profile that is a maximum near the source and diminishes further from the source.

Therefore, a method of diffusion doping a silica glass article with an alkali metal that overcomes the challenges discussed above is desired.

### SUMMARY OF THE INVENTION

In one aspect, the invention relates to a method of making an optical fiber precursor which comprises generating vapors from an alkali metal source comprising a compound containing oxygen and an alkali metal and applying the vapors to a surface of a glass article comprising silica at a temperature that promotes diffusion of the alkali metal into the surface of the glass article.

In another aspect, the invention relates to an optical fiber having a core comprising silica and an alkali metal oxide of the form X₂O, where X is selected from the group consisting of K, Na, Li, Cs, and Rb, wherein a concentration of the alkali metal oxide is uniform along a length of the core.

Using the methods disclosed herein, K₂O dopant levels between 0.1 and about 5 weight percent have been achieved in consolidated glass tubes. Lower and higher levels can be obtained by manipulating the vapor pressure of the alkali precursor, the diffusion temperature, or the relative concentration of the alkali metal precursor to other alkali sources. Other features and advantages of the invention will be apparent from the following description and the appended claims.

### BRIEF DESCRIPTION OF THE DRAWINGS

FIG. 1 illustrates a prior-art arrangement to diffuse an alkali metal into a silica glass tube.

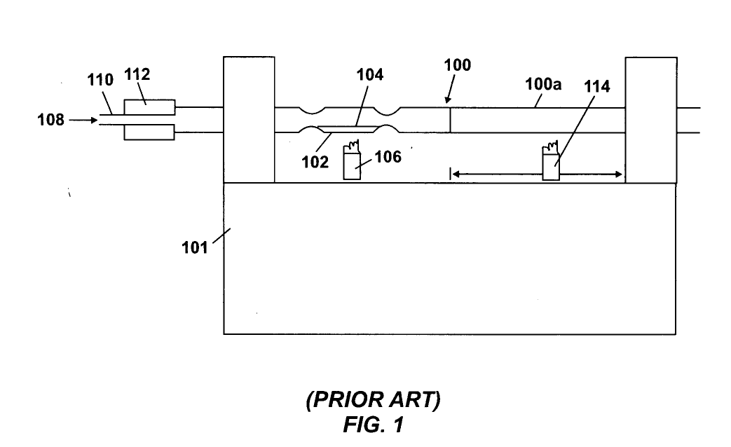

FIG. 2A shows the vapor pressure of potassium bromide and potassium oxide as a function of p(O₂) and temperature.

FIG. 2B shows the vapor pressure of potassium oxide as a function of p(O₂) and temperature.

FIG. 3 shows an arrangement to diffuse an alkali metal into a silica glass article according to an embodiment of the invention.

FIG. 4 shows an arrangement to diffuse an alkali metal into a silica glass article according to another embodiment of the invention.

### DETAILED DESCRIPTION OF THE INVENTION

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

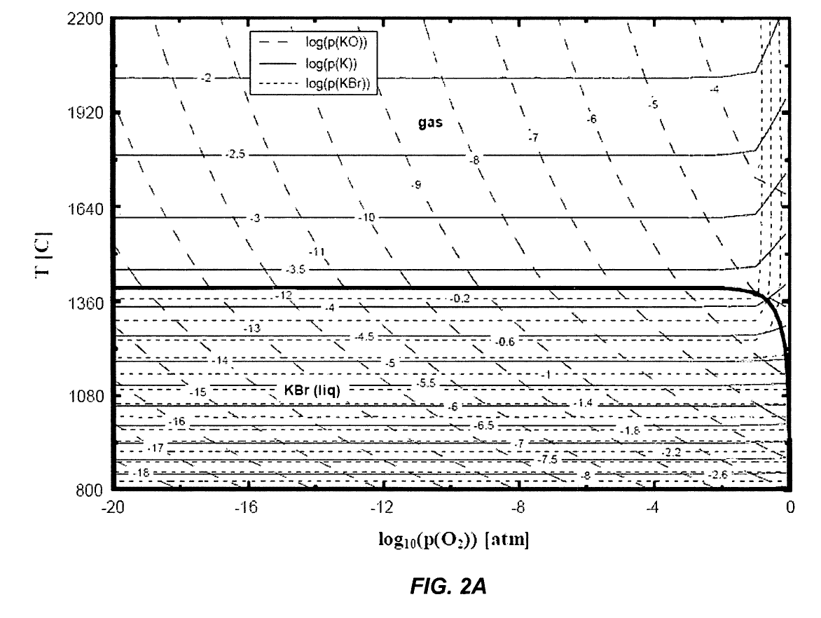

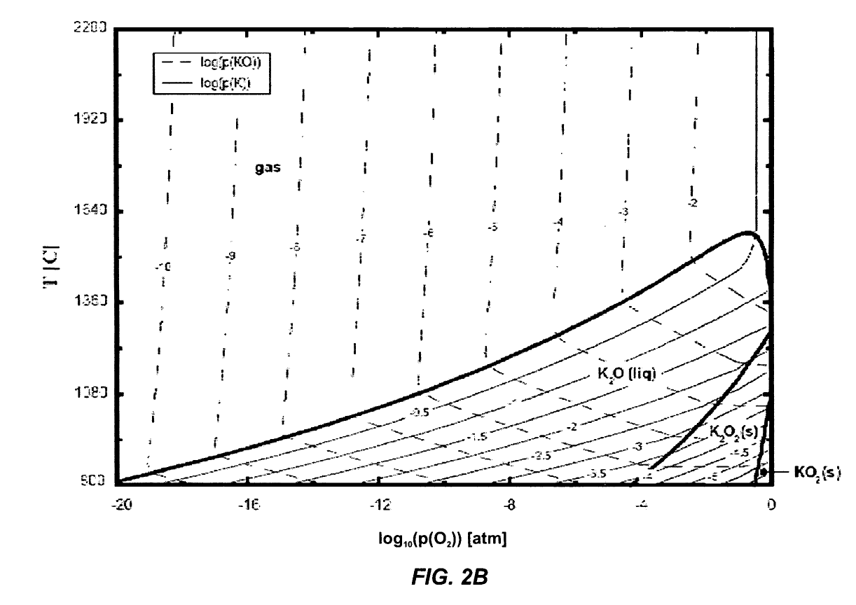

As previously discussed, oxygen is required to participate in diffusion doping of silica glass when the alkali metal source is an alkali metal halide. In this case, oxygen combines with the alkali metal halide to form alkali metal oxide, which then diffuses into a surface of the silica glass. However at temperatures suitable for diffusion doping of silica glass, the presence of halide significantly lowers the vapor pressure of alkali metal oxide, which correspondingly lowers the amount of alkali metal that can be incorporated into the silica glass. FIG. 2A shows the vapor pressure of potassium bromide and potassium oxide as functions of vapor pressure of oxygen (p(O₂)) and temperature. At the elevated temperature suitable for diffusion doping, e.g., ≧1500° C., the vapor pressure of potassium bromide (p(KBr)) and neutral potassium (p(K)) make up nearly all of the potassium species present in the vapor, and the vapor pressure of potassium oxide (p(KO)) is comparably several orders of magnitude lower. Very similar results are obtained for any other choice of halide and for any other choice of alkali metal. In contrast, FIG. 2B shows the vapor pressure of potassium oxide and neutral potassium as functions of vapor pressure of oxygen and temperature in the absence of halide. These conditions result in vapor pressures of potassium oxide that are 2 to 3 orders of magnitude higher than when a halide is present.

In view of the above, the inventors provide an alkali metal source that enables a desired level of alkali metal to be incorporated into a silica glass article by diffusion doping. In one aspect, the alkali metal source is comprised entirely of a compound containing oxygen and one or more alkali metals of interest. Alternatively, the alkali metal source may be comprised partly of the compound containing oxygen. The remainder of the metal source may be comprised, for example, of one or more alkali metals of interest and a secondary compound containing one or more of the alkali metals of interest. As an example, the secondary compound could be an alkali metal halide. The compound containing oxygen and alkali metal may be an alkali oxide, oxysalt, hydroxide, oralkoxide. Examples of suitable alkali and oxygen-containing compounds include, but are not limited to, alkali oxides, peroxides, and super oxides, alkali nitrates and suboxides of nitrates, alkali oxyhalide salts, such as hypochlorite, chlorite, chlorate, perchlorate and analogs involving bromine or iodine, and alkali hydroxide and alkali alkoxides, provided that the protons in the hydroxyls or alkoxides are replaced with deuterium.

The inventors also provide a method of diffusion doping a silica glass article using the alkali metal source above. In a further aspect, the doped silica glass article formed by the method of the invention may be used to form an optical fiber precursor. The term “optical fiber precursor,” as used herein, refers to a complete optical fiber preform or a precursor to a complete optical fiber preform, such as, for example, a core cane or a deposition tube. The term “core cane,” as used herein, refers to a consolidated glass precursor to an optical fiber preform that is not a complete optical fiber preform but that includes at least a portion of the core. The term “optical fiber preform,” as used herein, refers to a consolidated glass article ready for drawing into an optical fiber. An alkali metal level in the optical fiber precursor of 0.01 to 6 mole percent, preferably 0.01 to 3 more percent, computed on the basis of oxides, is considered useful for making an optical fiber with low intrinsic scattering loss. An optical fiber precursor according to an embodiment of the invention may initially have an alkali metal peak level that is higher than what is actually required to make an optical fiber with low intrinsic scattering loss. However, because of the high diffusivity of alkali metals at high temperature, this peak level will reduce to the appropriate level during drawing of the optical fiber precursor.

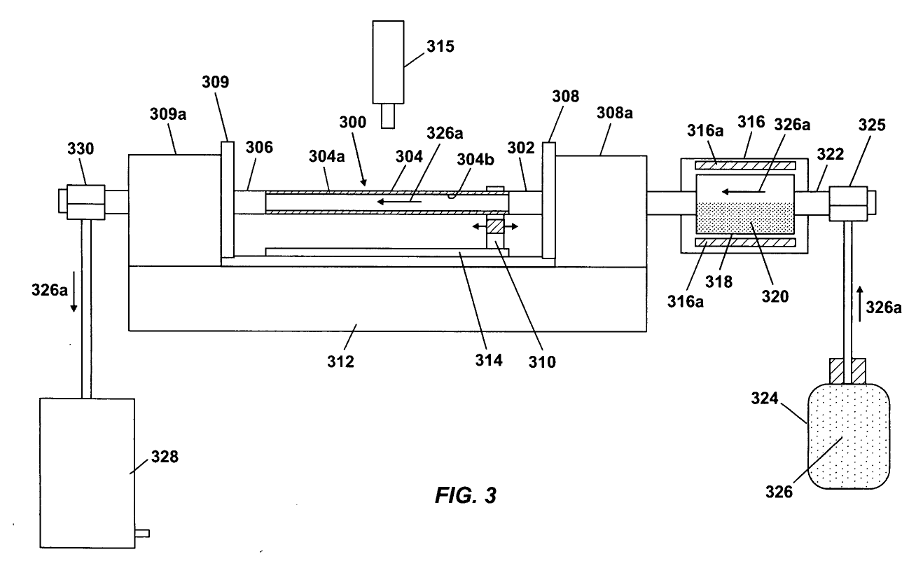

FIG. 3 illustrates a process for diffusion doping a silica glass article according to one embodiment of the invention. The process starts with a glass tube 300, which may be formed by any suitable CVD process and is preferably suitable for manufacture of an optical fiber. In the embodiment illustrated, the glass tube 300 has an inlet tube 302, a preform tube 304, and an outlet tube 306. The glass tube 300 may be a single piece (i.e., the demarcations between the inlet and outlet tubes 302, 306 and preform tube 304 is fictitious) or may be a composite tube (i.e., formed by fusing the inlet and outlet tubes 302, 306 to the ends of the preform tube 304). In the case where the glass tube 300 is a composite tube, the inlet tube 302 and the outlet tube 306 preferably have the same (or similar) characteristics as (to) the preform tube 304.

The preform tube 304 is preferably a high purity silica glass tube containing at least 80 mole percent SiO₂, preferably at least 90 mole percent SiO₂, most preferably>95 mol percent. The preform tube 304 may also contain one or more dopants. Examples of dopants useful in optical fibers include, but are not limited to, Cl, F, Al₂O₃, CaO, GeO₂, and P. It is desirable that the preform tube 304 is essentially free of OH, which is responsible for an absorption peak at or about 1383 nm that can extend into the operating wavelength regions of an optical fiber and thereby increase fiber attenuation. Preferably, the OH content of the preform tube 304 is less than approximately 100 ppb, more preferably less than approximately 20 ppb. To avoid alkali chloride crystallization in the preform tube 304, it is also desirable that the preform tube 304 is essentially free of chlorine. Preferably, the preform tube 304 contains less than about 500 ppm chlorine, more preferably less than about 100 ppm, most preferably less than about 50 ppm chlorine.

The inlet tube 302 and the outlet tube 306 are rotatably supported in chucks 308 and 309, respectively, of a glass-forming lathe 312, such as a conventional modified chemical vapor deposition (MCVD) glass-forming lathe. The headstocks 308a, 309a of the lathe 312 include the mechanisms necessary for rotating the inlet and outlet tubes 302, 306, respectively. The preform tube 304 rotates in unison with the inlet and outlet tubes 302, 306 since it is coupled to the inlet and outlet tubes 302, 306. A heater 310 is mounted adjacent the preform tube 304 to provide heat to the preform tube 304 as necessary. The heater 310 may partially or fully circumscribe the preform tube 304. Examples of devices that can serve as the heater 310 include, but are not limited to, gas burners, such as an oxygen-hydrogen burner, and induction heaters. The heater 310 is supported on a translation stage 314, which allows the heater 310 to be translated along the length of the preform tube 304. A pyrometer 315 is supported above the preform tube 304 to monitor the temperature of the preform tube 304. The pyrometer 315 allows non-invasive measurement of the temperature of the preform 304. However, other suitable invasive or non-invasive approaches may be used to monitor the temperature of the preform tube 304.

A furnace 316 external to the glass-forming lathe 312 encloses a reservoir 318, which contains an alkali metal source 320 according to an embodiment of the invention. The alkali metal source 320 includes at least an oxide compound containing at least one alkali metal, which may be selected from the group consisting of K, Na, Li, Cs, and Rb. The alkali metal source 320 may additionally include a secondary compound containing the alkali metal, e.g., a halide salt of the alkali metal. The alkali metal source 320 may initially be in liquid or solid form. The furnace 316 includes heating elements 316a for heating the reservoir 318 and the alkali metal source 320 contained therein to a desired temperature. However, the invention is not limited to enclosing the reservoir 318 in the furnace 316. Also, any suitable device, such as a resistance or induction heater or torch, may be used to heat the reservoir 318 and the alkali metal source 320 contained therein. The inlet tube 302 connects to one end of the reservoir 318. A gas tube 322 connects to the other end of the reservoir 318. The gas tube 322 communicates with a gas source 324 through a rotary union or seal 325. The outlet tube 306 communicates with a gas treatment chamber 328 through a rotary union or seal 330. Carrier gas 326 circulates from the gas source 324 to the gas treatment chamber 328 as indicated by arrows 326a.

In operation, the alkali metal source 320 is heated in the furnace 316. Then, flow of carrier gas 326 is started. Because the alkali metal source 320 is heated enough to produce vapors of the alkali metal source 320, the carrier gas 326 flowing over the alkali metal source 320 entrains the alkali metal source 320 vapors and carries the vapors into the preform tube 304. The heater 310 is adjusted to deliver heat to the preform tube 304 at a temperature that would promote rapid diffusion of the alkali metal in the alkali metal source 320 vapors into the inner surface 304b of the preform tube 304. Typically, this temperature is at least 1500° C., preferably at least 1750° C., more preferably at least 2000° C. A diffusion pass includes positioning the heater 310 at one end of the preform tube 304, preferably the end closest to the inlet tube 302, and then translating the heater 310 (at the operating condition mentioned above) along the length of the preform tube 304 as the carrier gas 326 flows through the preform tube 304. The heater provided to the wall 304a of the preform tube 304 facilitates diffusion of the alkali metal entrained by the carrier gas 326 into the inner surface 304b of the preform tube. The diffusion pass ends when the heater 310 reaches the other end of the preform 304, i.e., the end closest to the outlet tube 306. Additional diffusion passes can be made to incorporate more alkali metal into the inner surface 304b of the preform tube or to drive alkali metal incorporated in the preform tube 304 in previous diffusion passes deeper into the wall 304a of the preform tube 304. The latter occurs if the carrier gas 326 does not carry vapors of the alkali metal source 320 into the preform tube 304, e.g., if the alkali metal source 320 is too cold to produce vapors or has been exhausted.

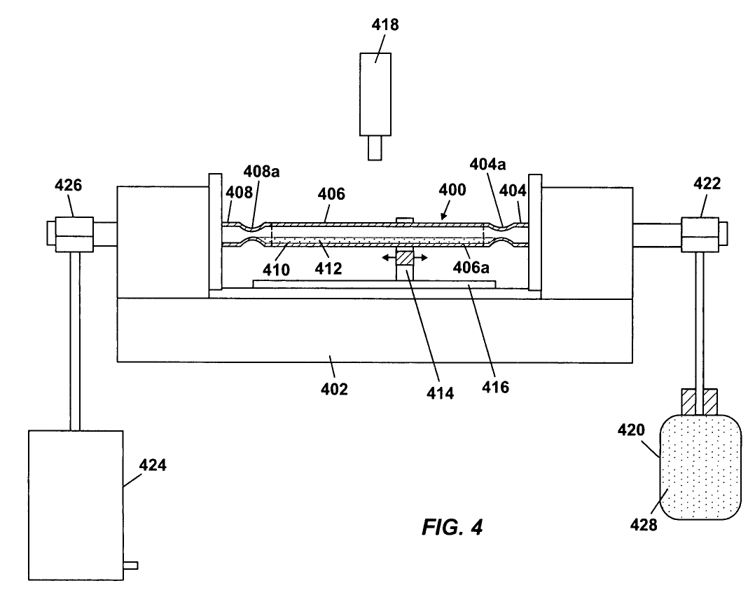

In the present invention, the presence of an oxygen counter-ion to the alkali metal at the silica/vapor interface (i.e., inner surface 304b) permits uniform doping along the length of the preform tube 304 and obviates the need for oxygen as a carrier gas. The latter is particularly valuable in cases in which sensitivity to excess oxygen is important (e.g., burn-out of germanium in Ge-doped silica, or incorporation of molecular oxygen in silica that then leads to hydrogen aging). Since oxygen as a carrier gas is minimized or perhaps no longer necessary, the alkali metal source 320 can be loaded directly into the preform tube 304 and heated to produce vapors, which can diffuse directly into the inner surface 304b of the preform tube 304 provided that the temperature of the wall 304a of the preform tube 304 promotes such diffusion. This allows the preform tube 304 to be used as a reservoir for the alkali metal source 320, in which case any reservoir external to the preform tube 304, such as reservoir 318, can be eliminated. This is illustrated more clearly in FIG. 4.

FIG. 4 illustrates a process for diffusion doping silica glass according to another embodiment of the invention. In this embodiment, a glass tube 400 is supported in a glass-forming lathe 402. It is again convenient in this embodiment to imagine that the glass tube 400 has an inlet tube 404, a preform tube 406, and an outlet tube 408. The inlet and outlet tubes 404, 408 include constrictions 404a, 408a, respectively. The constrictions 404a, 408a allow the preform tube 406 to function as a reservoir 410 for holding an alkali metal source 412. When the alkali metal source 412 is loaded in the reservoir 410 as shown, the alkali metal source 412 is in direct contact with the inner surface 406a of the preform tube 406. A heater 414 is provided adjacent the preform tube 406. The heater 414 is mounted on a translation stage 416 as previously described for the embodiment illustrated in FIG. 3. A pyrometer 418 is also provided to monitor the temperature of the preform tube 406.

In operation, the heater 414 is adjusted to heat the preform tube 406 to a first temperature. This first temperature facilitates conversion of the alkali metal source 412 to vapors. The heater 414 is translated along the length of the preform tube 404 to uniformly heat the preform tube 406 and the alkali metal source 412 contained therein to the first temperature. Then, the heater 414 is preferably adjusted to heat the preform tube 406 to a second temperature. This second temperature is typically higher than the first temperature and would promote more rapid diffusion of the alkali metal in the alkali metal source 412 into the inner surface 406a of the preform tube 406. A diffusion pass includes translating the heater 414 from one end of the preform tube 406 to the other end of the preform 406 at the second temperature. While the alkali metal source 412 is not exhausted, the alkali metal in the alkali metal source 412 diffuses directly into the inner surface 406a of the preform tube 406. The preform tube 406 is rotated during this process so that the alkali metal is evenly distributed on the inner surface of the preform tube 406. Multiple diffusion passes can be made to incorporate additional alkali metal in the preform tube 406. After the alkali metal source 412 is exhausted, subsequent diffusion passes will serve to drive the alkali metal incorporated in the preform tube 406 during previous diffusion passes further into the wall of the preform tube 406. Thus, there is no need for a separate oxygen carrier gas since oxygen is already present in the alkali metal source 412 and the alkali metal source 412 is in direct contact with the inner surface 406a of the preform tube 406. However, a cover gas comprising oxygen or a neutral gas, e.g., a noble gas or nitrogen, may be desirable to keep the constrictions 404a, 408a from becoming plugged. In this case, a gas source 420 containing a suitable gas 428 can be coupled to the inlet tube 404 through, for example, a rotary seal 422, and a gas treatment chamber 424 can be coupled to the outlet tube 408 through, for example, a rotary seal 426. Gas 428 from the gas source 420 can then be circulated through the system as desired.

After completing diffusion doping of the preform tube (304 in FIG. 3, 406 in FIG. 4), the glass tube (300 in FIG. 3, 400 in FIG. 4) may be collapsed into a solid glass rod by further heating. Prior to collapsing the glass tube, it may be desirable to rapidly cool the glass tube, e.g., to a temperature of about 900° C., to prevent devitrification. The cooled glass tube may then be reheated and collapsed into a solid glass rod when desired. The ends of the glass rod including the previous inlet and outlet tubes (302, 306 in FIG. 3, 404, 408 in FIG. 4) can be trimmed off, if desired, and the remainder of the glass rod may be used as an optical fiber precursor. The optical fiber precursor may be drawn into a fiber without further processing. Alternatively, additional glass material, such as additional core or cladding material, may be deposited on the optical fiber precursor using suitable processes, e.g., chemical vapor deposition processes such as OVD, and the resulting preform can be drawn into a fiber. In one embodiment, the optical fiber precursor has an alkali metal level such that when it is drawn into a fiber the core of the fiber has an alkali metal level (computed on the basis of oxides) in a range from 0.1 to 6 mole percent, preferably in a range from 0.1 to 3 mole percent. In one embodiment, the alkali metal level is highest at the center of the core and decreases in a direction away from the core.

The following examples are presented for illustration purposes only and are not to be construed as limiting the invention as otherwise described herein.

### EXAMPLE 1

A powdered mixture is prepared using 12.5 g potassium bromide and 12.5 g potassium superoxide. The powder is preferentially mixed in a water-free atmosphere so as to eliminate hydration of the super oxide. The oxide, peroxide, or super oxide of any other alkali metal could be used in conjunction with an appropriate halide. The powder is loaded into the reservoir (318 in FIG. 3). The powder is heated to approximately 900° C. and allowed to equilibrate for several minutes. A carrier gas is flowed over the surface of the molten salt solution and down through a silica glass tube at a rate of one liter per minute. The carrier gas may be oxygen or other suitably neutral gas. An oxygen-hydrogen burner is used as the heater (310 in FIG. 3). The oxygen and hydrogen flow rates to the heater are adjusted to obtain a wall temperature on the silica glass tube of approximately 2080° C. The heater is then traversed along the silica glass tube, in a direction away from the reservoir, at a rate of 1 cm/min. This achieves the desired doping level. Additional diffusion passes can be performed if desired. If the reservoir remains hot, then the additional passes will serve to incorporate still more potassium into the tube. If the reservoir is cool, then the additional passes will drive alkali incorporated in previous diffusion passes deeper into the tube. Using this procedure to dope consolidated silica glass tubes, peak (i.e. the highest level at any point across the tube wall) levels of about 5 weight percent K₂O dopant have been achieved.

### EXAMPLE 2

A 25 g charge of potassium nitrate is loaded into the reservoir (318 in FIG. 3). The nitrate of any other alkali metal could be used instead if it is desired instead of potassium. The reservoir is heated to approximately 880° C. to melt the nitrate. A carrier gas is flowed over the surface of the molten nitrate and down the length of a silica glass tube. This carrier gas can be oxygen or any neutral gas. The oxygen and hydrogen gas flow rates to the heater (310 in FIG. 3) are adjusted to give a temperature of approximately 2080° C. The heater is then traversed down the silica glass tube, in a direction away from the reservoir, at a rate of approximately 1 cm/s. This accomplishes diffusion doping of the potassium into the surface of the silica glass tube. Additional heater passes may be performed to incorporate more of the potassium into the surface of the silica glass tube and/or drive the alkali metal deeper into the silica glass tube. Using this procedure, peak (i.e. the highest level across the tube wall) levels of about 1 weight percent K₂O dopant have been achieved.

### EXAMPLE 3

A 50 g charge of alkali nitrate is placed between constrictions (404a, 408a in FIG. 4) in a silica glass tube. Oxygen and hydrogen gas flow rates to a heater (414 in FIG. 4) are adjusted to levels that produce a tube wall temperature of about 1200° C. Then, the heater is traversed down the length of the silica glass tube at about 10 cm/min to melt the nitrate into a puddle. The gases supplied to the heater are adjusted to raise the wall temperature of the silica glass tube to approximately 2080° C. and a second pass is performed at 1 cm/min. The second slow high temperature pass causes alkali metal to diffuse into the silica glass tube. Additional heater passes may be performed to incorporate more of the potassium into the surface of the silica glass tube and/or drive the alkali metal deeper into the silica glass tube. Using this procedure, peak (i.e. the highest level across the tube wall) levels of about 2 weight percent K₂O dopant have been achieved.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of making an optical fiber precursor comprising:
generating vapors from an alkali metal source comprising a compound containing both oxygen and an alkali metal; and
applying the vapors to a surface of a glass article comprising silica at a temperature that promotes diffusion of the alkali metal into the surface of the glass article.

2. The method of claim 1, wherein the compound containing oxygen and alkali is selected from the group consisting of an oxide, an oxysalt, a hydroxide, and an alkoxide of the alkali metal.

3. The method of claim 1, wherein the alkali metal is selected from the group consisting of K, Na, Li, Cs, and Rb.

4. The method of claim 1, wherein the alkali metal source further comprises a secondary compound containing the alkali metal.

5. The method of claim 4, wherein the secondary compound is a halide compound.

6. The method of claim 5, wherein the halide compound is selected from the group consisting of a bromide, chloride, fluoride, and iodide of the alkali metal.

7. The method of claim 1, wherein the glass article is in the form of a tube.

8. The method of claim 7, wherein applying the vapors comprises entraining the vapors in a carrier gas and flowing the carrier gas through the tube.

9. The method of claim 7, further comprising forming a reservoir in the tube for containing the alkali metal source.

10. The method of claim 9, wherein applying the vapors comprises heating the reservoir to a first temperature which would facilitate conversion of the alkali metal source to vapors.

11. The method of claim 10, wherein the first temperature is less than the temperature that promotes diffusion of the alkali metal.

12. The method of claim 7, further comprising collapsing the glass article to form a solid glass rod.

13. The method of claim 12, further comprising drawing the solid glass rod into an optical fiber.

14. The method of claim 12, further comprising depositing additional glass material on the solid glass rod to form a complete optical fiber preform.

15. The method of claim 14, further comprising drawing the optical fiber preform into an optical fiber.

16. The method of claim 1, wherein applying the vapors comprises translating a heater along a length of the glass article, wherein the heater heats the glass article to the temperature that promotes diffusion of the alkali metal.

17. The method of claim 16, further comprising multiple applications of the vapors to the surface of the glass article.

18. The method of claim 1, wherein the glass article comprises at least 80 mole percent silica.
